(19) United States
(12) Patent Application Publication
(10) Pub. No.: US 2011/0235636 A1
(43) Pub. Date: Sep. 29, 2011

(54) MOBILE AD HOC NETWORK AND METHOD FOR ESTABLISHING ROUTING THEREOF

(75) Inventors: Pi-Cheng Hsiu, Kaohsiung City (TW); Tei-Wei Kuo, Taipei County (TW); Ai-Chun Pang, Taipei County (TW); Yung-Chih Liu, Taipei City (TW); Chun-Wei Chou, Taipei City (TW)

(73) Assignee: INSTITUTE FOR INFORMATION INDUSTRY, Taipei (TW)

(21) Appl. No.: 12/778,129

(22) Filed: May 12, 2010

(30) Foreign Application Priority Data
Mar. 23, 2010 (TW) 99108555

(51) Int. Cl. H04L 12/56

(52) U.S. Cl. 370/390

(57) ABSTRACT

A mobile ad hoc network (MANET) and a method for establishing a routing thereof are provided. The MANET includes a plurality of nodes. Each node determines a corresponding parent node according to a request packet resource of a request packet and a node resource of each node, so as to establish transmission routes between the nodes. Furthermore, needless transmission route is eliminated by the node belonging to a multicast group according to a group table of each node.

### CROSS-REFERENCE TO RELATED APPLICATION

This application claims the priority benefit of Taiwan application serial no. 99108555, filed on Mar. 23, 2010. The entirety of the above-mentioned patent application is hereby incorporated by reference herein and made a part of specification.

### BACKGROUND OF THE INVENTION

1. Field of the Invention

The present invention relates to a mobile ad hoc network, and more particularly to a mobile ad hoc network with optimized variable resource allocation and a method for establishing a routing thereof.

2. Description of Related Art

In the current network development, the mobile ad hoc network (MANET) is a wireless network communication system without establishing the base environment in advance. In the mobile ad hoc network, there is no centralized control mechanism, and the nodes cooperate with each other and share the limited bandwidth. Further, each of the nodes is not only a host but also a router. Any note can receives packet from or transmits packet to other notes. All of the nodes possess the characteristic of mobility and are capable of supporting the transmission (the non-broadcasting transmission) involving a mass of nodes within the same area. Under the cooperative routing, each of the nodes can transmit data in a way of multihop to other nodes.

However, this kind of network faces the challenge is that all of the nodes are moving and the moving variation is unpredictable. Hence, there are technical problems of dynamically establish the routing and the ad hoc on-demand distance vector (AODV). Nevertheless, AODV can only establish one route for communication without considering all kinds of variable resources (such as power capacity, loading, available bandwidth) in the network. Currently, the Internet Engineering Task Force(IETF) MANET Group sets AODV as the standard of the unicast on the network. The unicast needs to periodic maintains the routes and the unicast can effectively operate only if the environmental variation is small. If all of the nodes are moving, the way of unicast turns to be resource-consuming. Moreover, other communication technology with resource allocation concept (such as the general packet radio service, GPRS) is implemented by using the backhaul network and establishing the resource map for centralized control.

### SUMMARY OF THE INVENTION

The invention provides a method for establishing a routing of a mobile ad hoc network capable of effectively allocating network resource and allocating the resource according to the system requirement so that the goals of the lowest power-consumption and the lowest loading-consumption of the whole network can be achieved.

The invention provides a mobile ad hoc network without establishing the whole network resource map in advance and without using centralized control.

The present invention provides a method for establishing a routing of a mobile ad hoc network. The mobile ad hoc network comprises a plurality of nodes and the nodes include an origin node of a multicast group. the origin node broadcasts a request packet and the rest of the nodes transmits the request packet, wherein a rout table of each of the nodes records a node resource of the node and the request packet includes a request packet resource. Each of the nodes determines a corresponding parent node according to the request packet resource of the request packet received by the node and the node resource of the node so as to establish at least a transmission route between the nodes. The node belonging to a multicast group eliminates a needless transmission route according to a group table of each of the nodes.

According to one embodiment of the present invention, the node resource comprises a resource weight value, a resource-consuming weight value, an external weight value, a packet-transmission energy and a packet-forwarding energy. The resource weight value denotes a residual resource, the resource-consuming weight value denotes a resource consumed by each of the node for receiving the request packet and the external weight value is obtained by performing an evaluation algorithm. The aforementioned request packet resource includes the external weight value of the source node and the available residual resource capacity. The available residual resource capacity is obtained by subtracting the resource-consuming weight value from the resource weight value of the source node.

According to one embodiment of the present invention, the step of determining the corresponding parent node by each of the nodes comprises checking whether the route table records the corresponding node resource by the destination node when a destination node among the nodes receives the request packet. If the rout table of the destination node does not record the corresponding node resource, the corresponding node resource is established. An external evaluation weight value is calculated according to the evaluation algorithm so as to compare the external evaluation weight value with the external weight value. When the external evaluation weight value is larger than the external weight value, the external weight value is replaced by the external evaluation weight value, and the external evaluation weight value is written into a corresponding field in the rout table of the destination node, and the corresponding parent node of the destination node is set to be a source node of the request packet.

According to one embodiment of the present invention, the aforementioned evaluation algorithm is:

Q=min {M_{U},(T_{U}−X_{UV}), T_{V}}∘

Wherein, Q denotes the external evaluation weight value, M_{U} denotes the external weight value of the source node U of the request packet, T_{U} denotes the available residual resource capacity of the request packet, X_{UV} denotes the resource-consuming weight value for the source node U transmitting the request packet to the destination node V and T_{V} denotes the available residual resource capacity of the destination node.

According to one embodiment of the present invention, in the step of eliminating a needless transmission route by the node belonging to a multicast group, each of the nodes except the origin node self-checks a multicast data table to determine whether the node belongs to the multicast group. Each of the nodes belonging to the multicast group transmits a response packet to the corresponding parent node so as to determine the packet-forwarding energy of each of the nodes according to the response packet resource of each of the response packets and the node resource of each of the nodes. The aforementioned response packet resource includes the parent node of the source node transmitting the response packet and the packet-transmission energy. When the node not belonging to the multicast group receives the response packet transmitted by the nodes belonging to the multicast group, transmitting another response packet to the parent node of the node not belonging to the multicast group by the node not belonging to the multicast group.

According to one embodiment of the present invention, each of the nodes receiving the response packet checks the packet-transmission energy in the response packet and compares the packet-transmission energy in the response packet with the packet-forwarding energy in its route table. When the packet-transmission energy is larger than the packet-forwarding energy, the packet-transmission energy is used to replace the packet-forwarding energy and is filled in the corresponding field of the route table.

According to one embodiment of the present invention, after the step of self-checking the multicast data table by each of the nodes except the origin node, the corresponding member flag in corresponding route table as invocation by each of the nodes belonging to the multicast group.

According to one embodiment of the present invention, each of the nodes except the origin node self-checks the member flag in the corresponding route table. If the member flag is set as non-invocation, the member flag is set as invocation and the node establishes another response packet to its parent node.

The present invention provides a mobile ad hoc network comprising a plurality of nodes. Each of the nodes comprises a route table. The nodes include an origin node and a plurality of communication nodes. The origin node belongs to a multicast group and is used to broadcast a request packet. The request packet includes a request packet resource. The aforementioned communication nodes are used to transmit the request packet respectively. Each of the communication nodes determines a corresponding parent node according to the request packet resource of the request packet received by the communication node and the node resource of the route table of the communication node so as to establish at least a transmission route between the origin node and the communication nodes. The communication nodes belonging to the multicast group eliminate the needless transmission routes according to a group table of each of the communication nodes.

Accordingly, in the present invention, the variable resource allocation is used as an operation evaluation basis of the routing. Hence, the network resource can be effectively allocated, and the types of resources are allocated according to the system requirements so that the goals of the lowest power-consumption and the lowest loading-consumption of the whole network can be achieved.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart showing the method for establishing a routing of a mobile ad hoc network according to one embodiment of the present invention.

FIG. 2 is a schematic view of a route table format according to one embodiment of the present invention.

FIG. 3 is a schematic view of a request packet format according to one embodiment of the present invention.

FIG. 4 is a flow chart illustrating a method for establishing a network topology according to one embodiment of the present invention.

FIG. 5 is a schematic view of a response packet format according to one embodiment consistent with the invention.

FIGS. 6A, 6B and 6C are schematic views showing a method for establishing a routing according to one embodiment of the present invention.

FIGS. 7A through 7F are schematic views showing a method for establishing a network topology according to one embodiment of the present invention.

FIG. 8A and FIG. 8B are schematic views showing a method for selecting a transmission route according to one embodiment of the present invention.

### DESCRIPTION OF EMBODIMENTS

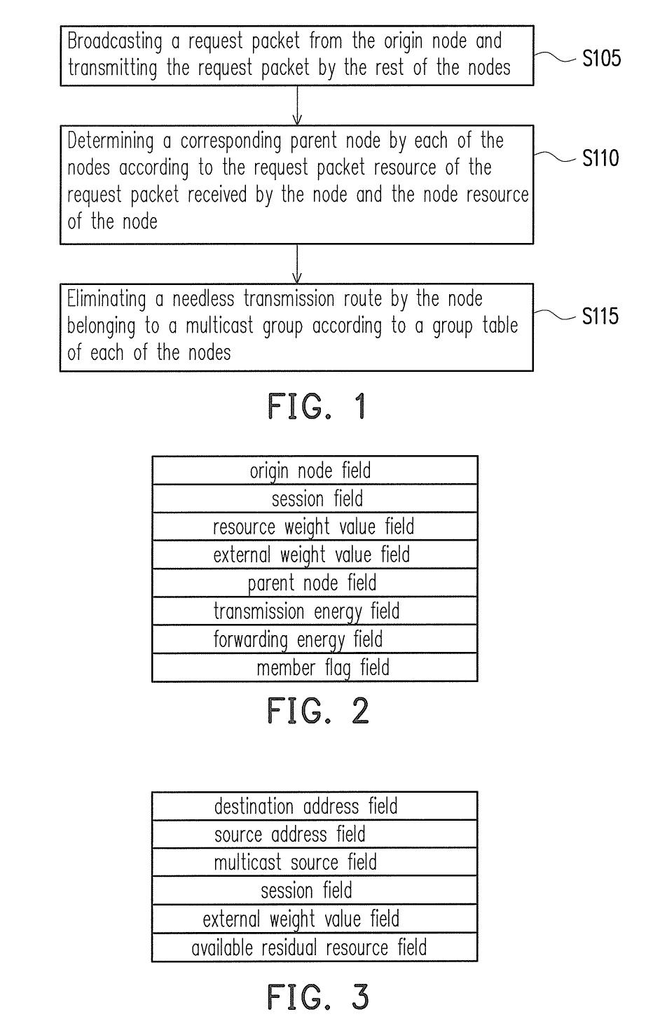

FIG. 1 is a flowchart showing the method for establishing a routing of a mobile ad hoc network according to one embodiment of the present invention. In the present embodiment, a mobile ad hoc network comprises a plurality of nodes and the nodes include an origin node of a multicast group so that the progress of the method for establishing routes starts at the source node. As shown in FIG. 1, in the step S105, the origin node starts to broadcast a request packet and the request packet is transmitted by the rest of the nodes respectively.

Herein, a route table of each of the nodes in the mobile ad hoc network records the corresponding node resource respectively. The node resource comprises a resource weight value, a resource-consuming weight value, an external weight value, a packet-transmission energy and a packet-forwarding energy. The resource weight value denotes a residual resource, the resource-consuming weight value denotes a resource consumed by each of the node for receiving the request packet and the external weight value is obtained by performing an evaluation algorithm. An embodiment is illustrated below for further detailing the route table format.

FIG. 2 is a schematic view of a route table format according to one embodiment of the present invention. The route table comprises an origin node field, a session field, a resource weight value field, an external weight value field, a parent node field, a transmission energy field, a forwarding energy field and a member flag field.

The origin node field is used to record an address of the origin node of the multicast group which the node belongs to. The session field is used to record a session serial number of the multicast. The external weight value field is used to record the external weight value (herein, the external weight value is obtained according to an evaluation algorithm). The parent node field is used to record an address of the parent node of the node. The transmission energy field is used to record the packet-transmission energy necessary for the parent node transmitting a packet to the node. The forwarding energy field is used to record the packet-forwarding energy for the node transmitting a packet to the next node. The member flag field is used to record a member flag.

The origin node starts to broadcast a request packet with a fixed energy to the reachable nodes and the nodes receiving the request packet forward the request packet to other nodes so as to establish all transmission routes within the mobile ad hoc network. An embodiment is illustrated below for further detailing the request format. FIG. 3 is a schematic view of a request packet format according to one embodiment of the present invention. The request packet comprises a destination address field, a source address field, a multicast source field, a session field, an external weight value field and an available residual resource field.

The destination address field is used to record addresses of the nodes to be broadcasted. The source address field is used to record an address of the node (source node) transmitting the request packet. The session field is used to record a session serial number of the multicast. The external weight value field is used to record an address of the source node of the request packet. The available residual resource field is used to record an available residual resource capacity of the source node of the request packet (which is obtained by subtracting the resource-consuming weight value from the resource weight value of the source node).

In the step S110, a parent node of each of the nodes is respectively determined by each of the nodes according to the request packet resource of the request packet received by the node and the node resource of the node so as to establish at least a transmission route between the nodes.

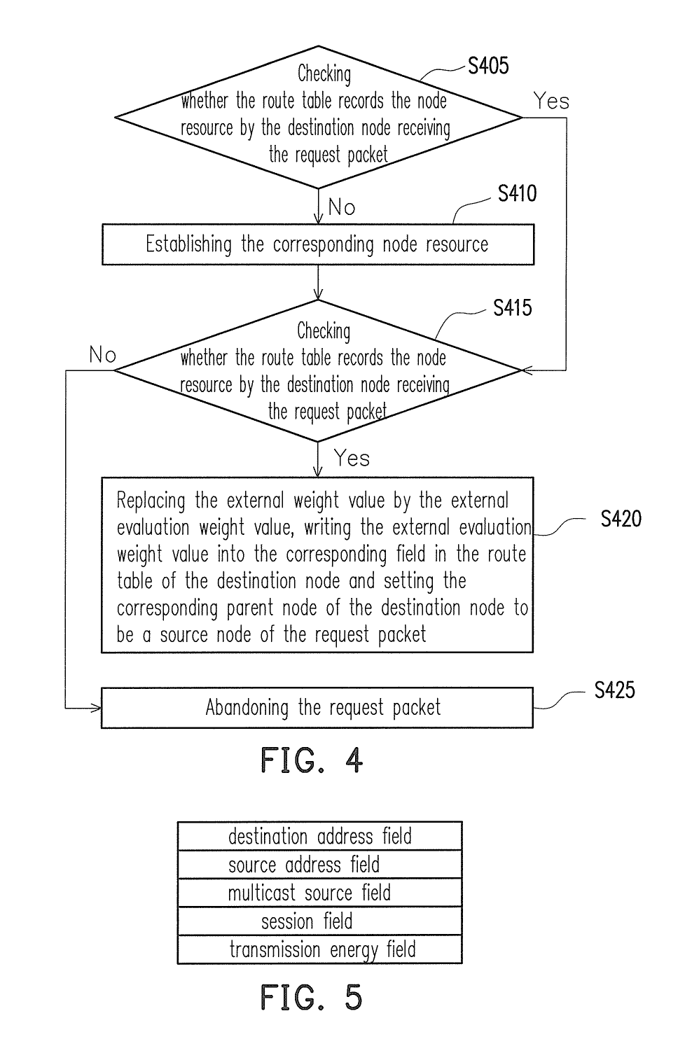

For instance, FIG. 4 is a flow chart illustrating a method for establishing a network topology according to one embodiment of the present invention. As shown in FIG. 4, in the step S405, each of the nodes receiving the request packet checks whether the route table records the node resource.

When the route table does not record the node resource, the node resource is established as shown in the step S410. For instance, each of the nodes receiving the request packet sets an initial value of the external weight value to be zero and captures an instant available resource of the node to be the resource weight value, and then the member flag in the route table is set to be non-invocation. The step S415 is then proceeded. On the other hand, when the route table has already recorded the node resource, the step S415 proceeded.

In the step S415, each of the nodes receiving the request packet calculates the external evaluation weight value according to the evaluation algorithm so as to compare the external evaluation weight value with the external weight value. In the present embodiment, the evaluation algorithm is as following:

Q=min {M_{U}, (T_{U}−X_{UV}), T_{V}}∘

Wherein, Q denotes the external evaluation weight value, M_{U} denotes the external weight value of the source node U of the request packet, T_{U} denotes the available residual resource capacity of the request packet (which is obtained by subtracting the resource-consuming weight value from the resource weight value of the source node), X_{UV} denotes the resource-consuming weight value for the source node U transmitting the request packet to the destination node V and T_{V} denotes the available residual resource capacity of the destination node.

When the external evaluation weight value is larger than the external weight value, the external weight value is replaced by the external evaluation weight value as shown in the step S420, and the external evaluation weight value is written into a corresponding field in the route table of the destination node and the parent node of the destination node is set to be a source node of the request packet. On the other hand, when the external evaluation weight value is smaller than the external weight value, the request packet is abandoned as shown in the step S425.

After each of the nodes receiving the request packet processes the aforementioned steps S405 through S425, the node establishes a new request packet. In the new request packet, the source address field is filled in with an address of the node, and the node (the source node) broadcasts with a fixed energy. Furthermore, the nodes receiving the new request packet process the aforementioned steps S405 through S425 as well. The rest can be done in the same way until the network topology is completely established.

In the step S115, according to a group table of each of the nodes, the nodes belonging to the multicast group eliminate needless transmission routes. Herein, after the node receives the request instruction and executes the forwarding process, the step S115 is proceeded when the node satisfies a specific condition. For instance, after the node receives the request instruction for a while (which can be done by the timer), the node processes the step S115.

Specifically, each of the nodes except the origin node checks its own a multicast data table to determine whether the node belongs to the multicast group. Each of the nodes belonging to the multicast group sets the member flag in its own route table as invocation. Moreover, each of the nodes belonging to the multicast group transmits a response packet to the corresponding parent node so as to determine the packet-forwarding energy of each of the nodes according to the response packet resource of each of the response packets and the node resource of each of the nodes. The aforementioned response packet resource includes the parent node of the source node transmitting the response packet and the packet-transmission energy. When the node not belonging to the multicast group receives the response packet transmitted by one of the nodes belonging to the multicast group, the node not belonging to the multicast group transmits another response packet to the parent node of the node not belonging to the multicast group.

FIG. 5 is a schematic view of a response packet format according to one embodiment consistent with the invention. The response packet comprises a destination address field, a source address field, a multicast source field, a session field and transmission energy field.

The destination address field is used to record an address of the parent node of the source node transmitting the response packet. The source address field is used to record an address of the source node transmitting the response packet. The multicast source field is used to record an address of the origin node of the multicast group. The session field is used to record a session serial number of the multicast. The transmission energy field is used to record a packet-transmission energy recorded in the route table of the source node transmitting the response packet.

That is, each of the nodes belonging to the multicast group transmits the response packet to its parent node so as to infoini its parent node that the transmission route therebetween is valid and also inform its parent node its packet-transmission energy. On the other hand, the nodes not belonging to the multicast group re-transmit the response packet to their parent nodes respectively only if the nodes not belonging to the multicast group receive the response packet. Accordingly, only the nodes not belonging to the multicast group and used for forwarding packet between the nodes belonging to the multicast group are reserved and the rest of the nodes not belonging to the multicast group are effectively eliminated. When the nodes not belonging to the multicast group receive the response packet, the aforementioned nodes are the ones used to forward packet.

Furthermore, each of the nodes receiving the response packet checks the packet-transmission energy in the response packet and compares the packet-transmission energy in the response packet with the packet-forwarding energy in its route table. When the packet-transmission energy is larger than the packet-forwarding energy, the packet-transmission energy is used to replace the packet-forwarding energy and is filled in the corresponding field of the route table. Accordingly, the destination node of the response packet can use the adequate energy to perform packet transmission with the source node of the response packet.

Moreover, when each of the nodes except for the origin node receives the response packet, it checks the member flag in its route table. If the member flag is set as non-invocation, the member flag is set as invocation and the node establishes another response packet to its parent node.

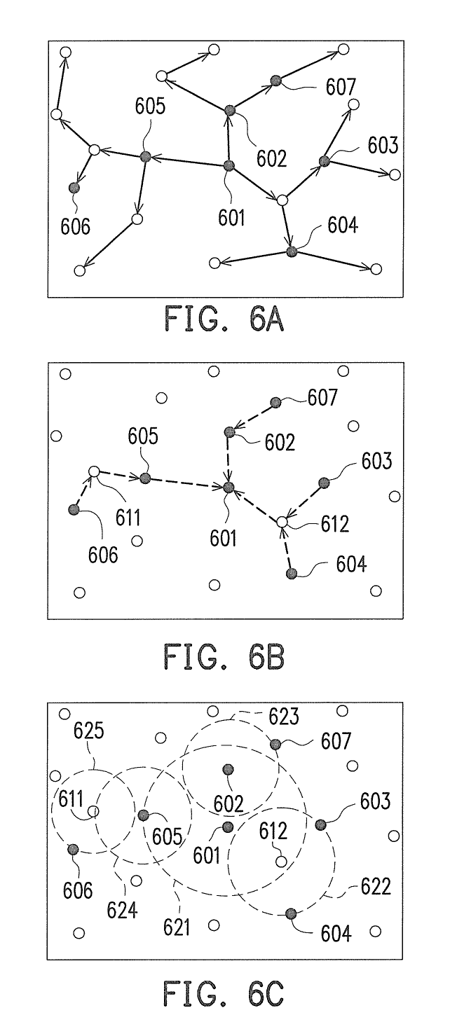

FIGS. 6A, 6B and 6C are schematic views showing a method for establishing a routing according to one embodiment of the present invention. In the present embodiment, the nodes 601 through 607 belong to the multicast group and are denoted as solid black dots respectively. Further, the nodes not belonging to the multicast group are denoted as white hollow dots.

According to the aforementioned steps S105 and S110, the network topology shown in FIG. 6A can be obtained. Further, the node 601 is the origin node. As shown in FIG. 6B, the needless nodes are eliminated according to the step S115. Herein, the nodes 611 and 612 among the nodes not belonging to the multicast group are reserved and the nodes 602 through 607, node 611 and node 612 point to the corresponding parent nodes respectively by a dotted arrow (the origin node 601 does not refer to any parent node). Moreover, in FIG. 6C, the dotted circles 621 through 625 represent the ranges of the packet-forwarding energy of the nodes 601, 612, 602, 605 and 611 respectively.

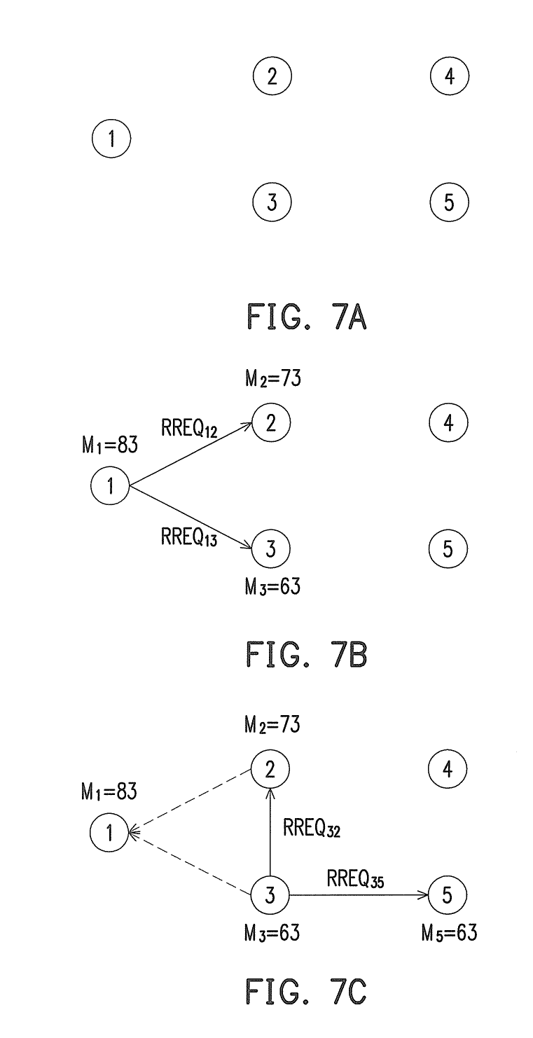

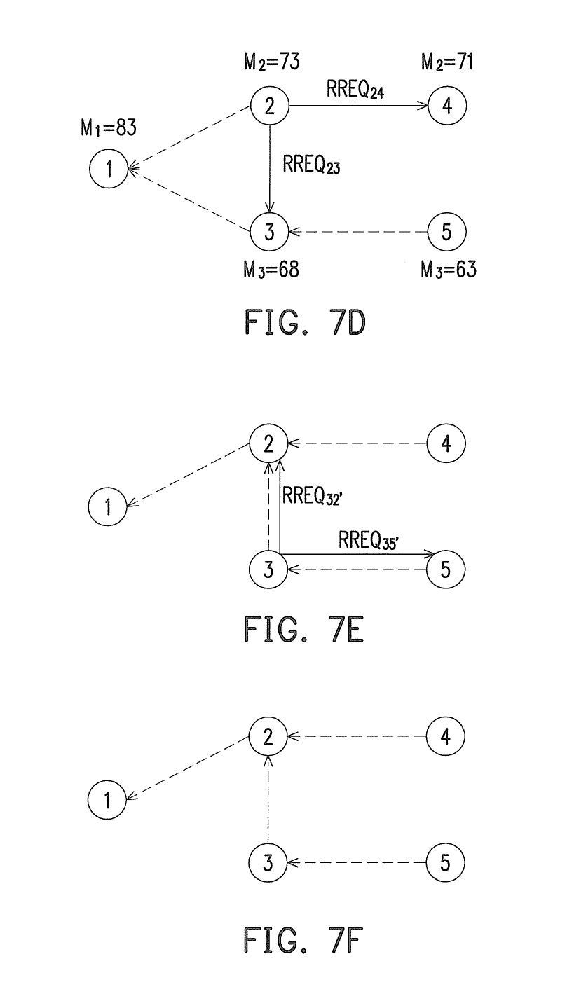

FIGS. 7A through 7F are schematic views showing a method for establishing a network topology according to one embodiment of the present invention. In the following embodiment, Bᵢ represent the resource weight value of the node i, Rᵢ represent the resource-consuming weight value of the node i, Mᵢ represent the external weight value of the node i, Tᵢ represent the residual resource capacity of node i, X_{UV} represent the available residual resource capacity of the resource-consuming weight value obtained by the node V to calculate according to the request packet received by the node V from the node U.

In FIG. 7A, the mobile ad hoc network comprises nodes 1 through 5. The node 1 is the origin node. Further, as for the node 1, B₁=85, R₁=2 and M₁=83 (B1−R1). As for the node 2, B₂=83, R₂=2 and M₂=0. As for the node 3, B₃=85, R₃=1 and M₃=0. As for the node 4, B₄=80, R₄=1 and M₄=0. As for the node 5, B₅=80, R₅=1 and M₅=0.

As shown in FIG. 7B, the node 1 broadcasts the request packet to the nodes 2 and 3. RREQ₁₂ represents the request packet transmitted to the node 2 and RREQ₁₃ represents the request packet transmitted to the node 3. As for the request packet RREQ₁₂, M₁=83, T₁=83 (B₁−R₁) and X₁₂=10. As for the request packet RREQ₁₃, M₁=83, T₁=83 (B₁−R₁) and X₁₃=20. X₁₂ and X₁₃ are estimated according to the intensity of the received request packet.

When the node 2 receives the request packet RREQ₁₂, the node 2 calculates an external evaluation weight value according to the aforementioned evaluation algorithm. That is, the external evaluation weight value is min {M₁=83, (T₁−X₁₂)=73, T₂=83}=73. Since the external evaluation weight value, which is 73, of the node 2 is larger than the external weight value, which is 0 (initial value), of node 2, the value 73 replaces the value 0 to be the external weight value of node 2. That is, M₂=73. Meanwhile, the parent node of the node 2 is set to be node 1.

Similarly, when the node 3 receives the request packet RREQ₁₃, the node 3 calculates an external evaluation weight value according to the aforementioned evaluation algorithm. That is, the external evaluation weight value is min {M₁=83, (T₁−X₁₃)=63, T₃=84}=63 (Q>M₃). Hence, the external weight value M₃ of the node 3 is 63. Meanwhile, the parent node of the node 3 is set to be node 1.

As shown in FIG. 7C, herein, the dotted arrows respectively point to the parent nodes (node 1) of the nodes 2 and 3. In FIG. 7C, the node 3 is used to forward the request packet. RREQ₃₂ represents the request packet transmitted to the node 2 and RREQ₃₅ represents the request packet transmitted to the node 5. As for the request packet RREQ₂₃, M₃=63, T₃=84 (B₃−R₃) and X₃₂=15. As for the request packet RREQ₃₅, M₃=63, T₃=84 and X₃₅=10. When the node 2 receives the request packet RREQ₃₂, the node 2 calculates an external evaluation weight value according to the aforementioned evaluation algorithm. That is, the external evaluation weight value is min {M₃=63, (T₃−X₃₂)=69, T₂=83}=63. Since the external evaluation weight value, which is 63, of the node 2 is not larger than the external weight value, which is 73, of the node 2, the node 2 abandons the request packet RREQ₃₂. Similarly, the node 5 obtains the external weight value M₅ equal to 63 according to the evaluation algorithm and sets the parent node of the node 5 to be node 3.

As shown in FIG. 7D, herein, the dotted arrow points to the parent node (node 3) of the nodes 5. In FIG. 7D, the node 2 is used to forward the request packet. RREQ₂₄ represents the request packet transmitted to the node 4 and RREQ₂₃ represents the request packet transmitted to the node 3. As for the request packet RREQ₂₄, M₂=73, T₂=83(B₂−R₂) and X₂₄=12. As for the request packet RREQ₂₃, M₂=73, T₂=83 and X₂₃=15. When the node 4 receives the request packet RREQ₂₄, the node 4 obtains the external weight value M₄ equal to 73 according to the evaluation algorithm and sets the parent node of the node 4 to be node 2.

Moreover, the node 3 obtains the external evaluation weight value, which is 68(min {M₂=73, (T₂−X₂₃)=68, T₃=84}), by receiving the request packet RREQ₂₃. The external evaluation weight value obtained by the node 3 is larger than M₃, which is recorded in the route table of node 3 and is equal to 63. Thus, value 68 replaces value 63 and is filled in the route table of the node 3. Meanwhile, the parent node of the node 3 is changed to be node 2.

As shown in FIG. 7E, herein, the dotted arrow points to the parent node (node 2) of the nodes 3. In FIG. 7E, since node 3 changes its parent node, the node 3 re-transmits the request packet. RREQ₃₂′ represents the request packet transmitted to the node 2 and RREQ₃₅′ represents the request packet transmitted to the node 5. As for the request packet RREQ_{32′}, M₃=68, T₃=83 and X₃₅=15. As for the request packet RREQ_{35′}, M₃=68, T₃=82 and X₃₅=10. When the node 2 receives the request packet RREQ₃₂, the node 2 calculates an external evaluation weight value according to the aforementioned evaluation algorithm. That is, the external evaluation weight value is min {M₃=68, (T₃−X₃₂)=68, T₂=83}=68. Since the external evaluation weight value, which is 68, of the node 2 is not larger than the external weight value, which is 73, of the node 2, the node 2 abandons the request packet RREQ_{32′}. Similarly, the node 5 obtains the external weight value M₅, which is 68, according to the evaluation algorithm. Finally, the transmission routes between the nodes 1 through 5 are shown in FIG. 7F, wherein the dotted arrows point to the parent nodes respectively.

It should be noticed that after satisfying a specific condition, the node receiving the request packet continues to proceed other processes. For instance, after a period of time, each of the nodes respectively transmits a response packet to its parent node. Another embodiment is illustrated in the following.

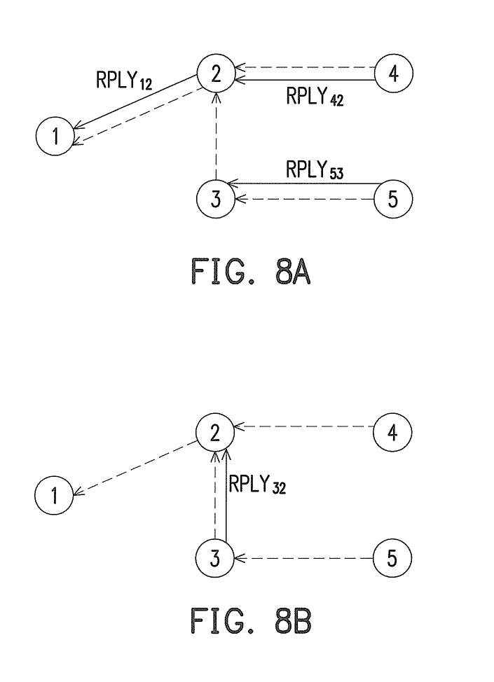

FIG. 8A and FIG. 8B are schematic views showing a method for selecting a transmission route according to one embodiment of the present invention. Following FIGS. 7A through 7F, in the present embodiment, it is assumed that the nodes 1, 2, 4 and 5 belong to a multicast group and the node 3 does not belong to the multicast group. In the following embodiment, Wᵢ represents the packet-transmission energy of the node i, Fᵢ represents the packet-forwarding energy of the node i and Gᵢ represents the member flag of the node i (Gᵢ=1 represents invocation and Gᵢ=0 represents non-invocation).

Referring to FIGS. 7F, 8A and 8B, as for the node 1 in FIG. 7F, W₁=0, F₁=0 and G₁=1. As for the node 2, W₂=10, F₂=0 and G₂=1. As for the node 3, W₃=15, F₃=0 and G₃=0. As for the node 4, W₄=12, F₄=0 and G₄=0. As for the node 5, W₅=10, F₅=0 and G₅=1.

As shown in FIG. 8A, the nodes belonging to the multicast group transmit a response packet to the corresponding parent nodes respectively. RPLY₁₂ represents the response packet transmitted from the node 2 to the node 1, RPLY₄₂ represents the response packet transmitted from the node 4 to the node 2 and RPLY₅₃ represents the response packet transmitted from the node 5 to the node 3.

The response packet RPLY₁₂ is used to inform the node 1 that “W₂ of the node 2 is 10”. When receiving the response packet RPLY₁₂, the node 1 fills 10 in the forwarding energy field corresponding to F₁. Meanwhile, F₁ of the node 1 is 10. In other words, the node 1 is capable of transmitting the packet to the node 2 with the packet-forwarding energy F₁, which is equal to 10.

The response packet RPLY₄₂ is used to inform the node 2 that “W₄ of the node 4 is 12”. When receiving the response packet RPLY₄₂, the node 2 fills 12 in the forwarding energy field corresponding to F₂. Meanwhile, F₂ of the node 2 is 12.

The response packet RPLY₅₃ is used to inform the node 3 that “W₅ of the node 5 is 10”. When receiving the response packet RPLY₅₃, the node 3 fills 10 in the forwarding energy field corresponding to F₃. Meanwhile, F₃ of the node 3 is 10.

Then, as shown in FIG. 8B, although the node 3 does not belong to the multicast group, the node 3 receives the response packet RPLY₅₃ transmitted by the node 5. That is, the node 3 is the parent node of the node 5 and the node 3 is the forwarding node in the multicast group. Accordingly, the node 3 also transmits a response packet RPLY₃₂ to its parent node (the node 2).

The response packet RPLY₃₂ is used to inform the node 2 that “W₃ of the node 3 is 15”. When receiving the response packet RPLY₃₂, the node 2 compares F₂ in the node 2. Herein, W₃ (=15) of the response packet is larger than F₂(=12) of the node 2 so that F₂ of the node 2 is renewed to be 15. The energy for the node 2 only transmitting the packet to the node 4 is 10. However, the node 2 also transmits the packet to the node 3 and the energy for the node 2 transmitting the packet to the node 3 is 15. Hence, it is necessary for the node 2 to renew the packet-forwarding energy.

After the response packet is transmitted as mentioned above, the multicast of the packet starts once the specific condition (such as after a period of time) is satisfied.

Specifically, the origin node starts to transmit the multicast packet. When other nodes receive the multicast packet, each of the nodes checks its route table to see if the route table records the node resource. If the route table does not records the node resource, the node abandons the multicast packet. On the other hand, if the route table records the node resource but the node does not proceed the steps of the multicast of the packet, the multicast packet is temporally reserved. When the node starts to proceed the steps of the multicast, the node determines whether the member flag in the route table is set to be invocation or non-invocation. If the member flag is set to be non-invocation, the node abandons the multicast packet. If the member flag is set to be invocation, the node transmits the multicast packet with the packet-forwarding energy recorded in the route table of the node.

In summary, the present invention has at least the following advantages:

1. The variable resource allocation is used as an operation evaluation basis of the routing.

2. The discrete structure is used without establishing the whole network resource map in advance and without using centralized control.

3. The network resource can be effectively allocated, and the types of the resources are allocated according to the system requirement so that the goals of the lowest power-consumption and the lowest loading-consumption of the whole network can be achieved.

4. It is not necessary to collect the route information in advance.

5. Each of the nodes only acknowledges the existences of its resource node and its neighboring nodes so that it is easy to extend the scale of the network.

6. The routing is established and the design of the new route table are on demand so that it is suitable for the high mobility network.

7. No matter the nodes move or the collisions occur among some packets, the transmission routes can be still established between the nodes.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for establishing a routing of a mobile ad hoc network, wherein the mobile ad hoc network comprises a plurality of nodes and the nodes include an origin node of a multicast group, the method comprising:
broadcasting a request packet from the origin node and transmitting the request packet by the rest of the nodes, wherein a route table of each of the nodes records a node resource of the node and the request packet includes a request packet resource;
determining a corresponding parent node by each of the nodes according to the request packet resource of the request packet received by the node and the node resource of the node so as to establish at least a transmission route between the nodes; and
eliminating a needless transmission route by the node belonging to a multicast group according to a group table of each of the nodes.

2. The method of claim 1, wherein the node resource comprises a resource weight value, a resource-consuming weight value, an external weight value, a packet-transmission energy and a packet-forwarding energy, and the resource weight value denotes a residual resource, the resource-consuming weight value denotes a resource consumed by each of the node for receiving the request packet and the external weight value is obtained by performing an evaluation algorithm;
the request packet resource comprises the external weight value and an available residual resource capacity of a source node of the nodes transmitting the request packet, wherein the available residual resource capacity is obtained by subtracting the resource-consuming weight value from the resource weight value of the source node.

3. The method of claim 2, wherein the step of determining the corresponding parent node by each of the nodes comprises:
when a destination node among the nodes receives the request packet, checking whether the route table records the corresponding node resource by the destination node;
if the route table of the destination node does not record the corresponding node resource, establishing the corresponding node resource;
calculating an external evaluation weight value according to the evaluation algorithm so as to compare the external evaluation weight value with the external weight value; and
when the external evaluation weight value is larger than the external weight value, replacing the external weight value by the external evaluation weight value, writing the external evaluation weight value into a corresponding field in the route table of the destination node and setting the corresponding parent node of the destination node to be a source node of the request packet.

4. The method of claim 3, wherein the step of establishing the corresponding node resource comprises:
setting an initial value of the external weight value is zero;
setting the resource weight value; and
setting a member flag recorded in a member flag field of the route table of the destination node as non-invocation.

5. The method of claim 3, wherein the evaluation algorithm is:
Q=min {M_{U}, (T_{U}−X_{UV}), T_{V}};
wherein, Q denotes the external evaluation weight value, M_{U} denotes the external weight value of the source node U of the request packet, T_{U} denotes the available residual resource capacity of the request packet, X_{UV} denotes the resource-consuming weight value for the source node U transmitting the request packet to the destination node V and T_{V} denotes the available residual resource capacity of the destination node.

6. The method of claim 3, wherein the step of eliminating a needless transmission route by the node belonging to a multicast group comprises:
self-checking a multicast data table by each of the nodes except the origin node to determine whether the node belongs to the multicast group;
transmitting a response packet by each of the nodes belonging to the multicast group to the corresponding parent nodes respectively so as to determine the packet-forwarding energy of each of the nodes according to a response packet resource of each of the response packet and the node resource of each of the nodes, wherein the response packet resource includes the parent node of the source node transmitting the response packet and the packet-transmission energy;
when the node not belonging to the multicast group receives the response packet transmitted by one of the nodes belonging to the multicast group, transmitting another response packet to the parent node of the node not belonging to the multicast group by the node not belonging to the multicast group.

7. The method of claim 6, further comprising:
checking the packet-transmission energy in the response packet by each of the nodes receiving the response packet and comparing the packet-transmission energy in the response packet with the corresponding packet-forwarding energy in the route table of the node by each of the nodes; and
when the packet-transmission energy is larger than the packet-forwarding energy, replacing the packet-forwarding energy by the packet-transmission energy and filling the packet-transmission energy in the corresponding field of the route table of the node.

8. The method of claim 6, wherein after the step of self-checking the multicast data table by each of the nodes except the origin node, further comprising:
setting the corresponding member flag in corresponding route table as invocation by each of the nodes belonging to the multicast group.

9. The method of claim 6, further comprising:
self-checking the member flag in the corresponding route table by each of the nodes except the origin node when each of the nodes except for the origin node receives the response packet; and
setting the member flag as invocation when the member flag is set as non-invocation and establishing another response packet to the corresponding parent node of the node by the node.

10. A mobile ad hoc network, comprising:
a plurality of nodes, wherein each of the nodes comprises a route table, and the nodes comprises:
an origin node belonging to a multicast group and broadcasting a request packet, wherein the request packet includes a request packet resource; and
a plurality of communication nodes transmitting the request packet respectively;
wherein, each of the communication nodes determines a parent node of the node according to the request packet resource of the received request packet and a node resource of the route table of each of the communication nodes so as to establish transmission routes between the communication nodes and the origin node; and eliminating the needless transmission routes by the communication nodes belonging to the multicast group according to a group table of each of the communication nodes.

11. The mobile ad hoc network of claim 10, wherein the node resource comprises a resource weight value, a resource-consuming weight value, an external weight value, a packet-transmission energy and a packet-forwarding energy, and the resource weight value denotes a residual resource, the resource-consuming weight value denotes a resource consumed by each of the node for receiving the request packet and the external weight value is obtained by performing an evaluation algorithm;
the request packet resource comprises the external weight value and an available residual resource capacity of a source node of the nodes transmitting the request packet, wherein the available residual resource capacity is obtained by subtracting the resource-consuming weight value from the resource weight value of the source node.

12. The mobile ad hoc network of claim 11, wherein when receiving the request packet, each of the communication nodes checks whether the route table records the node resource; if the route table does not record the node resource, the communication node establishes the node resource; and the communication node calculates an external evaluation weight value according to the evaluation algorithm so as to compare the external evaluation weight value with the external weight value; if the external evaluation weight value is larger than the external weight value, the external evaluation weight value replaces the external weight value and fills in the corresponding field in the route table and the corresponding parent node of the communication node is set to be the source node of the request packet.

13. The mobile ad hoc network of claim 11, wherein the evaluation algorithm is:
Q=min {M_{U}, (T_{U}−X_{UV}), T_{V}};
wherein, Q denotes the external evaluation weight value, M_{U} denotes the external
weight value of the source node U of the request packet, T_{U} denotes the available residual resource capacity of the request packet, X_{UV} denotes the resource-consuming weight value for the source node U transmitting the request packet to the destination node V and T_{V} denotes the available residual resource capacity of the destination node.

14. The mobile ad hoc network of claim 11, wherein each of the communication nodes further checks the corresponding multicast data table so as to determine whether the communication node belongs to the multicast group; the communication nodes belonging to the multicast group transmit a response packet to the respectively corresponding parent nodes so as to determine the packet-forwarding energy of each of the communication nodes according to a response packet resource of the response packet and the node resource of each of the communication nodes, wherein the response packet resource comprises the parent node of the source node transmitting the response packet and the packet-transmission energy; if the communication nodes not belonging to the multicast group receive the response packet transmitted by one of the communication nodes belonging to the multicast group, the communication nodes not belonging to the multicast group transmits another response packet to respectively the corresponding parent nodes.

15. A mobile ad hoc network of claim 14, wherein each of the communication nodes receiving the response packet checks the packet-transmission energy in the response packet and compares the packet-transmission energy with the packet-forwarding energy in the route table; if the packet-transmission energy is larger than the packet-forwarding energy, the packet-transmission energy replaces the packet-forwarding energy and fills in the corresponding field in the route table.
